(19) United States
(12) Patent Application Publication
(10) Pub. No.: US 2014/0258250 A1
(43) Pub. Date: Sep. 11, 2014

(54) Flexible Control Framework Featuring Standalone Rule Engine

(71) Applicant: SAP AG, Waldorf (DE)

(72) Inventors: Chris Ge, Walldorf (DE); Haiyang Yu, Shanghai (CN)

(73) Assignee: SAP AG, Waldorf (DE)

(21) Appl. No.: 13/849,290

(22) Filed: Mar. 22, 2013

(30) Foreign Application Priority Data
Mar. 8, 2013 (CN) 201310073536.1

(51) Int. Cl. G06F 17/30

(52) U.S. Cl. CPC G06F 17/30371
USPC 707/694

(57) ABSTRACT

A database system features a standalone rule-based engine that is decoupled from internal controls implemented by a separate existing control engine. The standalone rule engine is configured to execute business rules during runtime, in order to produce outcomes relevant to stored database information. The standalone rule engine offers enhanced flexibility, allowing its reuse by outside entities. For example, certain embodiments allow the outcomes of the standalone rule engine to be consumed by third parties, including but not limited to: Key Risk Indication (KRI), Audit Management, Analytics tools, and 3rd party compliance management tools.

### BACKGROUND

Embodiments of the present invention relate to analysis of database information, and in particular, to a flexible rule execution framework for use in compliance management and other applications.

Unless otherwise indicated herein, the approaches described in this section are not prior art to the claims in this application and are not admitted to be prior art by inclusion in this section.

Continuous Control Monitoring (CCM) functions to monitor and control internal operation of a system allowing interaction between a database and various applications receiving data therefrom. One example of such an application is compliance management, wherein data is examined for adherence to internal, domestic, and/or foreign laws, such as may govern privacy and security.

Conventionally, CCM and Compliance Management have been tightly coupled. For example, Compliance Management may be based upon Business Rules that are assigned to a Control before the execution. This rigidity in turn imposes limitation on the usages of CCM.

Accordingly, the present disclosure addresses these and other issues with systems and methods implementing a flexible rule execution framework for use in compliance and other purposes.

### SUMMARY

A database system features a standalone rule-based engine that is decoupled from internal controls implemented by a separate existing control engine. The standalone rule engine is configured to execute business rules during runtime, in order to produce outcomes relevant to stored database information. The standalone rule engine offers enhanced flexibility, allowing its reuse by outside entities. For example, certain embodiments allow the outcomes of the standalone rule engine to be consumed by third parties, including but not limited to: Key Risk Indication (KRI), Audit Management, Analytics tools, and 3rd party compliance management tools.

An embodiment of a computer-implemented method comprises providing a standalone rule engine separate from a control engine, in communication with a database, and causing the standalone rule engine to execute a job on data stored in the database in order to produce an outcome, without relying upon a control referenced by the control engine. The method further comprises causing the standalone rule engine to communicate the outcome to an external application.

An embodiment of a non-transitory computer readable storage medium embodies a computer program for performing a method comprising, providing a standalone rule engine separate from a control engine, in communication with a database, and causing the standalone rule engine to execute a job on data stored in the database in order to produce an outcome, without relying upon a control referenced by the control engine. The computer program is further configured to perform the method comprising causing the standalone rule engine to communicate the outcome to an external application.

An embodiment of a computer system comprises one or more processors and a software program executable on said computer system. The software program is configured to provide a standalone rule engine separate from a control engine, in communication with a database, and to cause the standalone rule engine to execute a job on data stored in the database in order to produce an outcome, without relying upon a control referenced by the control engine. The software program is further configured to cause the standalone rule engine to communicate the outcome to an external application.

Certain embodiments may further comprise providing an integration layer in communication with the standalone rule engine, the integration layer comprising a sub-system configured to perform a monitoring function.

In some embodiments, the external application may be configured to perform an audit management function.

According to particular embodiments, the external application may be configured to perform a risk management function.

In various embodiments, the standalone rule engine may be configured to reference a business rule to produce the outcome.

According to some embodiments, the business rule may include a definition and a connection to a data source.

The following detailed description and accompanying drawings provide a better understanding of the nature and advantages of particular embodiments.

### BRIEF DESCRIPTION OF THE DRAWINGS

FIG. 1 shows a simplified view of a system including a flexible rule execution framework according to an embodiment.

FIG. 2 shows a simplified process flow of flexible rule execution according to the embodiment of FIG. 1.

FIG. 2A is a sample screen shot indicating a sample business rule

FIG. 3 shows an example of a flexible rule execution framework for implementation with databases available from SAP AG.

FIG. 4 illustrates hardware of a special purpose computing machine configured to execute rules in a flexible framework according to an embodiment.

FIG. 5 illustrates an example of a computer system.

### DETAILED DESCRIPTION

Described herein are techniques for implementing a flexible framework for rule execution for compliance and other applications. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of various embodiments. It will be evident, however, to one skilled in the art that the present invention as defined by the claims may include some or all of the features in these examples alone or in combination with other features described below, and may further include modifications and equivalents of the features and concepts described herein.

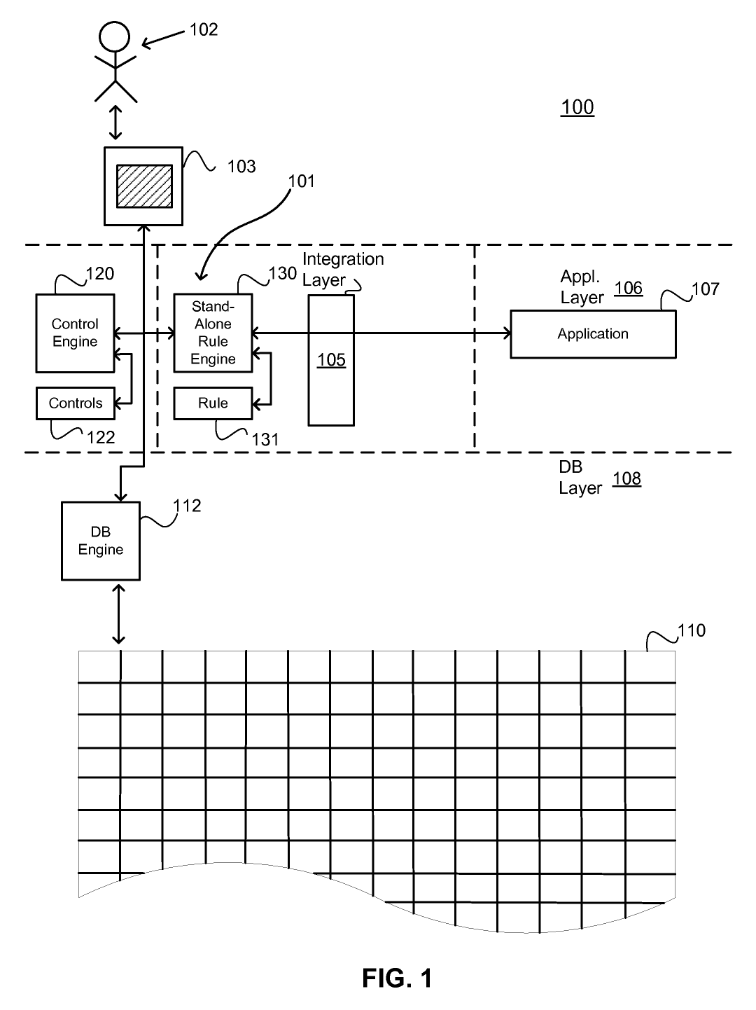

FIG. 1 shows a simplified view of a system 100 comprising a flexible rule execution framework 101 according to an embodiment. Specifically, a user 102 is configured to interact through a user device 103 (e.g. desktop, workstation, tablet, smartphone) with a conventional control engine 120 that is configured to reference one or more controls 122 relating to data of the database 110. In particular, the control engine accesses data from the database via a database engine 112.

The system 100 further includes a flexible framework 101 through which the user can access one or more applications 107 (including third party applications) present in an application layer 106. These applications utilize data stored in the underlying database 110 of the database layer. One example of such a business application is an Enterprise Resource Planning (ERP) application.

As shown in this FIG. 1, the flexible framework comprises a standalone rule engine 130. While it is linked to the control engine, the standalone rule engine 130 offers the flexibility of a separate component that is able to communicate with the database engine in order to perform certain tasks apart from those dictated by the control engine.

In particular, the standalone rule engine is in communication with a rule 131 (such as a business rule), in order to perform a function. The (business) rule may contain the definitions of criteria upon which the function is based, and may also contain connection(s) to data source(s) where the business data are laid in.

Specifically, the standalone rule engine is configured to communicate with the database engine, to perform compliance monitoring and/or other functionality. The standalone rule engine is able to communicate outcomes of such functionality to the application of the application layer (which may be a third party application), and ultimately, to the user.

The flexible framework 101 further includes an integration layer 105. As is explained below, the integration layer may include an ad-hoc issue reporting/handling subsystem useful in allowing the flexible framework to provide monitoring functionality.

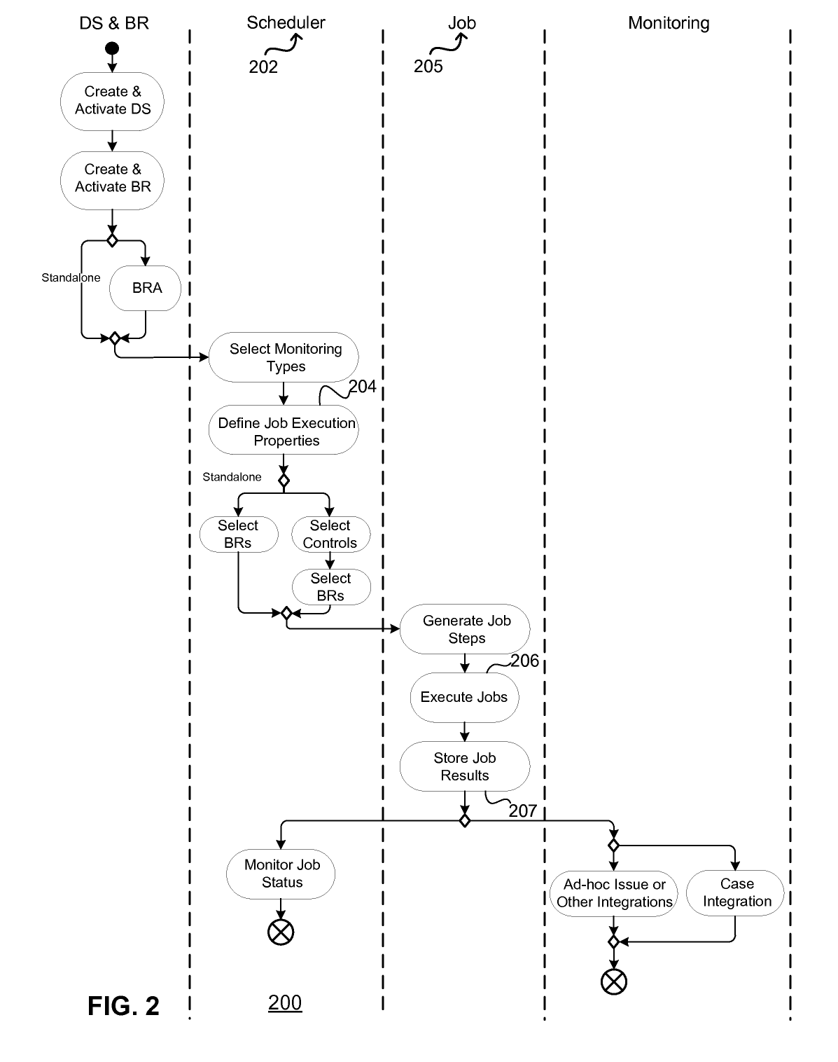

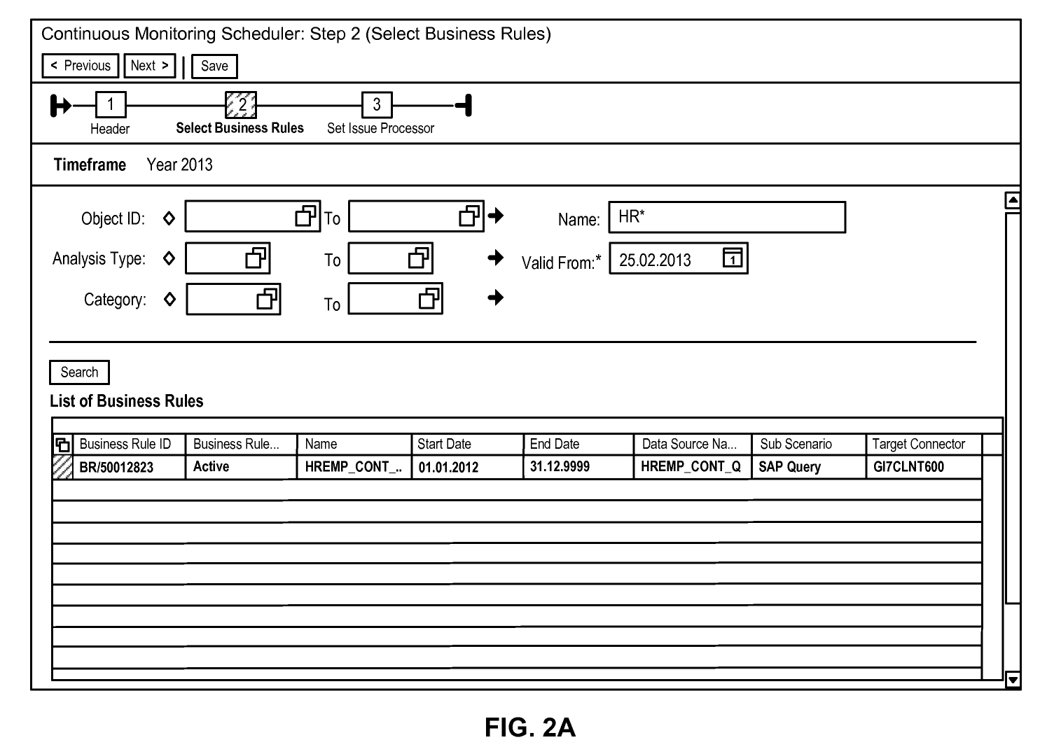

FIG. 2 shows a simplified process flow 200 of flexible rule execution according to the embodiment of FIG. 1. FIG. 2 traces pathways of operation of both the conventional control engine, and also the standalone rule engine.

In order to make Continuous Control Monitoring (CCM) easy to use, the standalone rule engine does not force a user to prepare a compliance structure prior to executing business rules (BRs). Instead, as shown in FIG. 2, once a Data Source (DS) is created and activated, the user starts the monitoring from the existing Job Scheduler 202, with an option available for standalone monitoring.

Thus, a user is not asked to select the controls as the central objects after connecting business rules to controls by performing business rule assignments. Instead, business rules are the only objects required, which contain the definitions of deficiencies and the connections to the data source where business data are laid in. FIG. 2A is a sample screen shot indicating a sample business rule.

Similarly, the job design time 204 generates the job steps based on factors such as the assigned business rules, connectors, and monitoring frequencies, and prepare them to be ready for execution. Once job start conditions 205 are reached, the job execution starts to collect the data from data sources, to apply business rules to calculate deficiencies, and to store the job results 207 to a Flexible Data Store (FDS).

### EXAMPLE

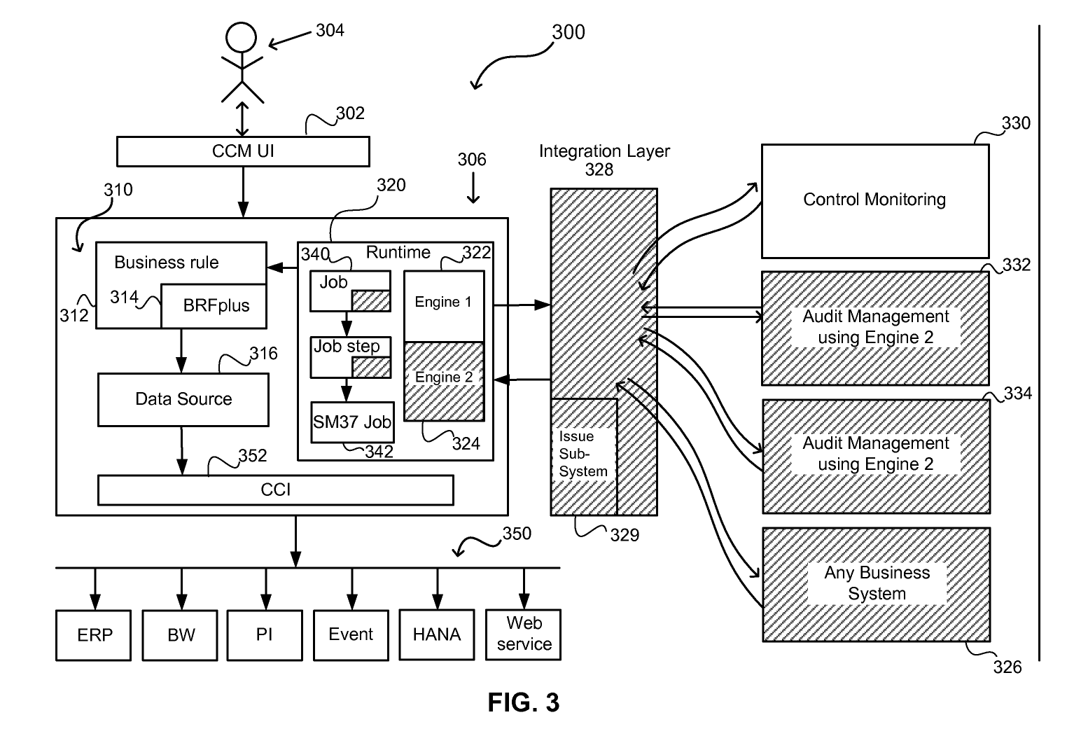

Further illustration of the flexible monitoring framework according to various embodiments, is now provided in connection with a specific example of a system that is designed to interact with a database available from SAP AG of Walldorf, Germany. In particular, FIG. 3 shows a simplified view of a system 300 which includes a CCM user interface (UI) 302 that is configured to allow a user 304 to interact with a CCM framework 306 according to an embodiment.

The CCM framework includes the following building blocks. A Design Time 310 building block includes a Business Rule engine 312 with the BRFplus rule set. 314.

The Design Time also includes a Data Source 316. The data source is in communication with one or more various outside sources 350 of information, via Common Connector Interface (CCI) 352. These various outside sources of information can include but are not limited to Enterprise Resource Planning (ERP) applications, Business Warehouses (BW), program integration (PI) applications, Event applications, databases (including the HANA in memory database available from SAP AG), and web services.

The CCM framework also includes a Run Time 320 building block. The Run Time building block includes a conventional compliance control based execution engine 322. Using this control engine 322, internal compliance and management tasks 330 may continue to be performed in the traditional manner.

Now, however, the Run Time building block also includes a standalone rule based execution engine 324. Using this standalone engine 324, certain tasks may be performed whose outcomes are available outside of the confines of the existing CCM framework. In particular, the engine 324 can be used for monitoring business process and organization status, which is a component in compliance management.

The standalone rule based execution engine may perform audit management tasks 332. As also shown in FIG. 3, the standalone rule based execution engine 324 may perform risk management tasks 334. The framework can be used to monitor risk status and to trigger alerts when particular criteria are met.

The framework proposed according to embodiments is flexible, in that it allows external access to monitoring and compliance outcomes that were formerly available only internally. Accordingly, FIG. 3 also shows the standalone rule based execution engine 324, as being in communication with one or more other business systems 326 via the integration layer 328.

In order to facilitate monitoring tasks, the integration layer further comprises an ad-hoc issue reporting/handling sub-system 329. Operation of this sub-system may be understood with reference to the lower right hand portion of FIG. 2 shown earlier.

FIG. 3 shows other components of the runtime building block 320 of the CCM. In particular, the Job Object is shown as 340, and the Flexible Data Store is shown as 342.

The job results of standalone CCM that are stored in FDS, may be in xml format. The job results can be exposed for various types of integration via service Application Programming Interfaces (APIs). Ad-hoc issues can be used by default for compliance workflows and reporting purposes.

Thus, by functioning as the monitoring services provider, the flexible CCM including the standalone engine, allows other products (e.g. as available from SAP, or as offered by 3rd parties) to consume the monitoring results easily. A user interface can support the various usages.

Flexible rule execution frameworks according to various embodiments, may offer certain benefits. Unlike conventional approaches involving tightly coupled monitoring and compliance, a standalone CCM according to embodiments does not create the case integration object at job design time and raise issues once deficiencies are found automatically. Embodiments featuring the standalone engine may rely upon an ad-hoc issue sub-system.

A standalone CCM may also offer certain benefits relating to innovation arising in the ongoing development of database technology. For example, Rule Chain, Rule Aggregation, and also Rule execution of the HANA in memory database available from SAP AG, can be evaluated.

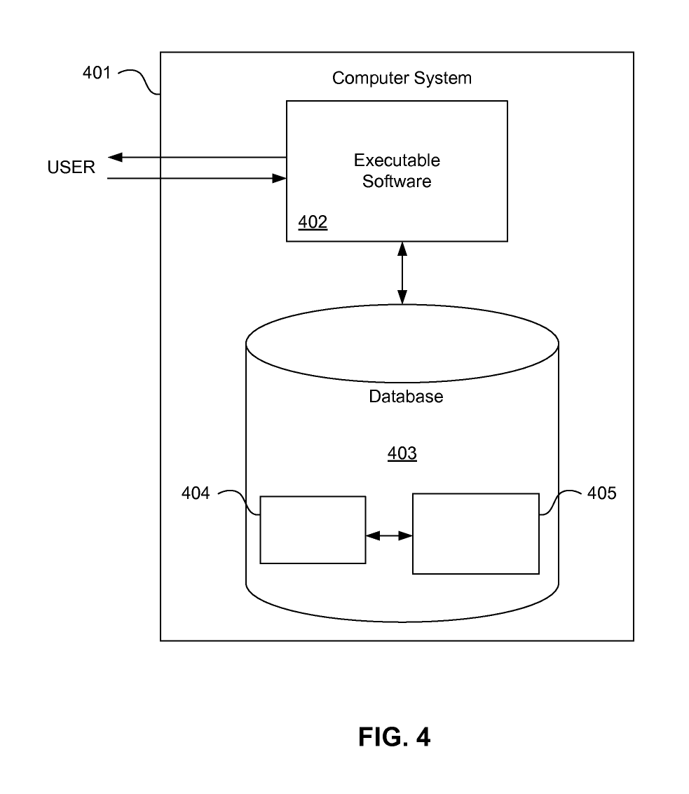

FIG. 4 illustrates hardware of a special purpose computing machine configured to provide a flexible rule execution framework according to an embodiment. In particular, computer system 400 comprises a processor 402 that is in electronic communication with a non-transitory computer-readable storage medium 403. This computer-readable storage medium has stored thereon code 405 corresponding to a standalone rule based execution engine. Code 404 corresponds to an integration layer. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

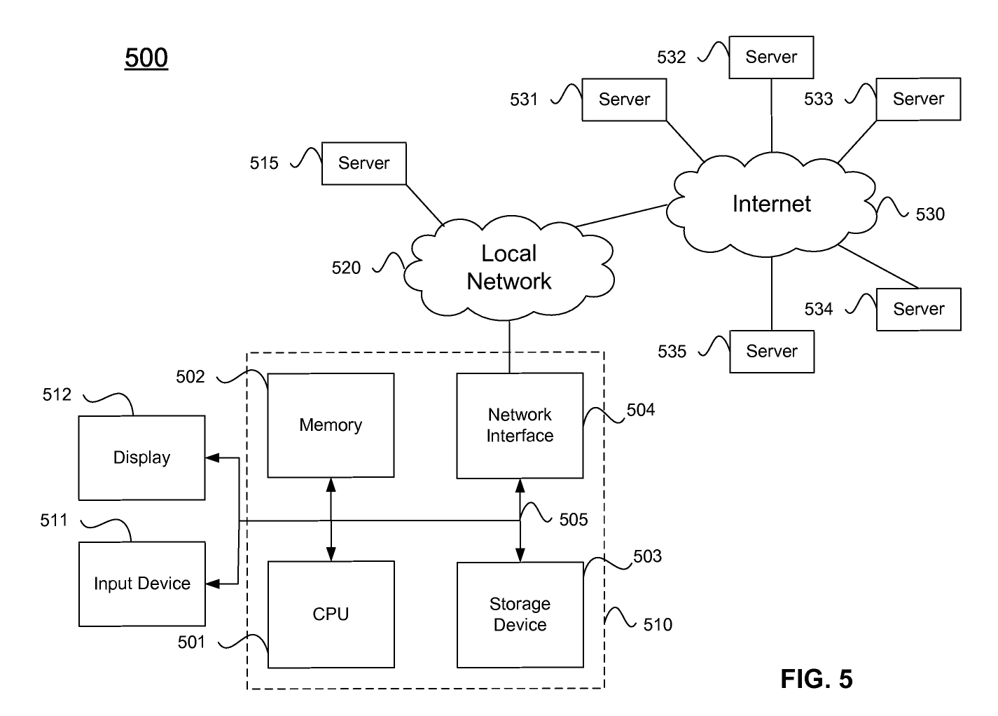

An example computer system 510 is illustrated in FIG. 5. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including information and instructions for performing the techniques described above, for example. This memory may also be used for storing variables or other intermediate information during execution of instructions to be executed by processor 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 503 may include source code, binary code, or software files for performing the techniques above, for example. Storage device and memory are both examples of computer readable mediums.

Computer system 510 may be coupled via bus 505 to a display 512, such as a cathode ray tube (CRT) or liquid crystal display (LCD), for displaying information to a computer user. An input device 511 such as a keyboard and/or mouse is coupled to bus 505 for communicating information and command selections from the user to processor 501. The combination of these components allows the user to communicate with the system. In some systems, bus 505 may be divided into multiple specialized buses.

Computer system 510 also includes a network interface 504 coupled with bus 505.

Network interface 504 may provide two-way data communication between computer system 510 and the local network 520. The network interface 504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 504 sends and receives electrical, electromagnetic, or optical signals that carry digital data streams representing various types of information.

Computer system 510 can send and receive information, including messages or other interface actions, through the network interface 504 across a local network 520, an

Intranet, or the Internet 530. For a local network, computer system 510 may communicate with a plurality of other computer machines, such as server 515. Accordingly, computer system 510 and server computer systems represented by server 515 may form a cloud computing network, which may be programmed with processes described herein. In the Internet example, software components or services may reside on multiple different computer systems 510 or servers 531-535 across the network. The processes described above may be implemented on one or more servers, for example. A server 531 may transmit actions or messages from one component, through Internet 530, local network 520, and network interface 504 to a component on computer system 510. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing a standalone rule engine separate from a control engine, in communication with a database;
causing the standalone rule engine to execute a job on data stored in the database in order to produce an outcome, without relying upon a control referenced by the control engine; and
causing the standalone rule engine to communicate the outcome to an external application.

2. A method as in claim 1 further comprising providing an integration layer in communication with the standalone rule engine, the integration layer comprising a sub-system configured to perform a monitoring function.

3. A method as in claim 1 wherein the external application is configured to perform an audit management function.

4. A method as in claim 1 wherein the external application is configured to perform a risk management function.

5. A method as in claim 1 wherein the standalone rule engine is configured to reference a business rule to produce the outcome.

6. A method as in claim 5 wherein the business rule includes a definition and a connection to a data source.

7. A non-transitory computer readable storage medium embodying a computer program for performing a method, said method comprising:
providing a standalone rule engine separate from a control engine, in communication with a database;
causing the standalone rule engine to execute a job on data stored in the database in order to produce an outcome, without relying upon a control referenced by the control engine; and
causing the standalone rule engine to communicate the outcome to an external application.

8. A non-transitory computer readable storage medium as in claim 7 wherein the method further comprises providing an integration layer in communication with the standalone rule engine, the integration layer comprising a sub-system configured to perform a monitoring function.

9. A non-transitory computer readable storage medium as in claim 7 wherein the external application is configured to perform an audit management function.

10. A non-transitory computer readable storage medium as in claim 7 wherein the external application is configured to perform a risk management function.

11. A non-transitory computer readable storage medium as in claim 7 wherein the standalone rule engine is configured to reference a business rule to produce the outcome.

12. A non-transitory computer readable storage medium as in claim 11 wherein the business rule includes a definition and a connection to a data source.

13. A computer system comprising:
one or more processors;
a software program, executable on said computer system, the software program configured to:
provide a standalone rule engine separate from a control engine, in communication with a database;
cause the standalone rule engine to execute a job on data stored in the database in order to produce an outcome, without relying upon a control referenced by the control engine; and
cause the standalone rule engine to communicate the outcome to an external application.

14. A computer system as in claim 13 wherein the software program is further configured to provide an integration layer in communication with the standalone rule engine, the integration layer comprising a sub-system configured to perform a monitoring function.

15. A computer system as in claim 13 wherein the external application is configured to perform an audit management function.

16. A computer system as in claim 13 wherein the external application is configured to perform a risk management function.

17. A computer system as in claim 13 wherein the standalone rule engine is configured to reference a business rule to produce the outcome.

18. A computer system as in claim 17 wherein the business rule includes a definition and a connection to a data source.
